(19) United States
(12) Patent Application Publication
(10) Pub. No.: US 2025/0066620 A1
(43) Pub. Date: Feb. 27, 2025

(54) WATER-BORNE HYBRID VARNISH AND THE METHOD OF ITS PREPARATION

(71) Applicants: Libor VOŠICKÝ, Brno (CZ); Martin KUBU, Brno (CZ); CENTRUM ORGANICKÉ CHEMIE S.R.O., Rybitvi (CZ); SYNPO, AKCIOVÁ SPOLECNOST, Pardubice (CZ); VYSOKÉ UCENÍ TECHNICKÉ V BRNE, Brno (CZ); UNIVERZITA TOMÁŠE BATI VE ZLÍNE, Zlin (CZ)

(72) Inventors: Libor VOŠICKÝ, Brno (CZ); Martin KUBU, Brno (CZ); Radka KORÍNKOVÁ, Tunechody (CZ); Lubomír KUBÁC, Rybitvi (CZ); Jakub OPRŠAL, Pardubice (CZ); Katerina ZETKOVÁ, Pardubice (CZ); Martina PUMMEROVÁ, Uhersky Brod (CZ); Vladimír SEDLARÍK, Zlin (CZ); Michal VESELÝ, Brno (CZ); Petr DZIK, Brno (CZ)

(21) Appl. No.: 18/721,981

(22) PCT Filed: Dec. 20, 2022
(86) PCT No.: PCT/CZ2022/050135

§ 371 Date: Jun. 20, 2024

(30) Foreign Application Priority Data
Dec. 21, 2021 (CZ) PV 2021-586

(51) Int. Cl. C09D 5/14; C09B 47/04; C09D 133/08; C09D 175/16; C09D 183/10

(52) U.S. Cl. CPC C09D 5/14; C09B 47/045; C09D 133/08; C09D 175/16; C09D 183/10

(57) ABSTRACT

The water-borne hybrid varnish is comprised of the hybrid polymer system on the basis of the silicone-acrylate-urethane thermosetting polymer comprising a biocidal preparation, and is further comprised of a photo-active component on the basis of a phthalocyanine derivative with aluminium or zinc as the central atom. The phthalocyanine derivative is fixed in the polymer mixture either in the form of aqueous dispersion of an unsubstituted pigment with particles of a size ranging from 100 to 300 nm, or via a reactive bond in the polymer matrix at a concentration ranging from 0.05 to 1.0% by weight.

### FIELD OF THE INVENTION

The invention relates to broad-spectrum protection against adhesion of bacteria, viruses, and/or yeasts; it specifically relates to water-borne hybrid varnish suitable for application onto frequently contaminated surfaces of publicly available equipment, and the method of its preparation.

### BACKGROUND OF THE INVENTION

In addition to droplet infection, communication via contaminated surfaces of publicly available equipment, such as handles or rails in public areas, and/or touch screens of displays in banks, regional government offices, schools, shops, or fast-food places is among the most frequently occurring forms of communication of infectious diseases caused by bacteria, viruses, and yeasts. Such surfaces are characterized in that a layer of biofilm gradually develops on them, where the respective microorganisms adhere and have favourable conditions to survive and be further communicated to a new host. Regardless of the long-time effort to maintain such premises regularly, the effect of disinfection interventions is very short-lasting, and within a very limited period of time after such a disinfection intervention, the risk of microorganisms readherence and subsequent communication of infectious diseases due to contact via the contaminated surfaces quickly increases.

Standard antimicrobial or biocidal procedures for the protection of surfaces are based on the application of biocidal agents comprised in biocidal products. These are preparations with direct effects on a certain species of microorganisms that are able to eliminate the growth of the microorganisms if used in a defined concentration. Such a type of action is known as biostatic effect. Another option is a complete destruction of the adherent microorganism, meaning biocidal effect. Biocidal preparations are subject to the registration process and no product that has not been previously tested and approved for a given type of application may be put on the market. Nevertheless, there has been a long-term effort to eliminate such preparations from widespread use due to the related frequently occurring negative effects on human health, such as dermatological diseases. Elimination of such preparations is desirable also on the grounds of their ecotoxicity. This goal can be attained by a significant reduction in biocidal agent concentration in biocidal preparations in applications under consideration. Finally, the valid legislation imposes the maximum possible concentrations in defined applications from the point of view of public health protection, where the concentration of biocidal agents is rather lower than the limit guaranteeing at least biostatic effect.

Another disadvantage of biocidal preparations containing biocidal agents is the fact that the microorganisms gradually develop resistance to the effect of a given preparation. Such a consequence is amplified in situations where biocidal agents are dosed into the system in limiting concentrations with respect to the aforementioned negative effects on human health and toxic effects. In technological systems, resistance of microorganisms to a specific biocidal agent is resolved by the cyclic rotation of biocidal agents eliminating resistance development. The disadvantage is that in the case of protection of surfaces against microbial contamination it is not possible to alter biocidal preparations applied on them. Another disadvantage is that the protection of surfaces must be broad-spectrum due to the plurality of microorganisms and viruses that may adhere on publicly accessible equipment. Such protection can only be accomplished by the application of various defined mixtures, which, however, implies a higher risk of side effects on human health and ecotoxicological effects.

An efficient system for protective polymer layers allowing the development of self-cleaning action with antimicrobial effect is the incorporation of oxides of inorganic metals such as titanium or zinc. In particular where such oxides are in the form of nanoparticles having a very large surface, a very efficient photocatalytic effect can be observed. Surfaces treated in this manner exposed to radiation with a wavelength ranging from 250 to 400 nm show a very efficient self-cleaning action. This action results from the radiation-induced generation of so-called free radicals that are very aggressive within their proximal environment. Free radicals deactivate organic pollutants or microorganisms adherent on the treated surface. Free radicals have been put on the list of registered active substances generated from photo-active precursors. A significant disadvantage of free radicals is that they can disintegrate also the carrier polymer matrix, which results in destruction of the entire carrier polymer system and release of photo-active nanoparticles into the environment of the treated surface. The solution is the hybrid polymer system disclosed in patent CZ 304812 and in the document by Kubáč L., Akrman J., Horálek J. et. al, Photoactive TiO₂ and its application for self-cleaning fabrics with long-term stability, Nanocon, 2013, 16.-18.10.2013. The inorganic-organic polymer has a higher resistance to the action of free radicals. Its application has been described in particular for a textile matrix with a self-cleaning effect. The polymer protects even the carrier polymer substrate against the action of free radicals. In the case of application onto transparent surfaces, however, such polymer layers doped with TiO₂ nanoparticles are not sufficiently transparent and create a cloudy film.

A large portion of surfaces of publicly accessible equipment are touch displays and buttons of payment terminals, cash dispensers, security and access-control devices, etc., where a completely transparent protective surface layer is required to support the key functionalities of such devices.

Application of photo-active agents based on phthalocyanine derivatives for deactivation of Gram-positive and Gram-negative bacteria as well as pathogenic yeasts is disclosed in patent CZ 303612. The use of phthalocyanine derivatives as photoactive agents with antimicrobial properties is also disclosed in a presentation by Kubáč L., Karásková M, Kořinková R. et. al, Alternative antimicrobial systems based on photo-active materials, Nice, 16. 10, 2014. The preparation in the form of xerogel is activated by irradiation using a source of red light to make the derivative generate an active, so-called singlet, form of molecular oxygen that is highly reactive and has biocidal effects on such microorganisms. A disadvantage is that if the photo-active agent is not irradiated by light with a suitable wavelength, the pollutants concerned are not degraded.

Patent CZ 304123 discloses the method of fixing a photo-active agent by a reactive bond in a fibre-forming polymer structure suitable for the preparation of nanofibres using the electrospinning technological process. With this treatment, photocatalytic effect remains unchanged and moreover, the nanofibres show large surface areas, thus increasing the total efficacy.

Patent CZ 305659 discloses the linkage of a photo-active agent to the columns of a core dispersion polymer carrier via ionic bonds. Incorporation of an organic photo-active agent into a layer of UV-curable varnish is also disclosed in patent CZ 306947. The photo-active agent thus shows photo-activity even in the case where it is fixed in or on a polymer matrix in a suitable manner. Furthermore, utility design CZ 27927 discloses the use of the photo-catalytic process as well as disposal of certain types of organic pollutants in an aqueous environment. The system is comprised of a cycle of osmotic filtration of organic substances and permeation of pure water and a cycle of photocatalytic reaction where degradation of such pollutants occurs due to the photocatalytic effect.

The use of the photocatalytic process in a self-cleaning process has been disclosed in utility design CZ 31976. The photo-active agent is incorporated by a reactive linkage to the structure of cellulose textile and upon irradiation, the degradation process of selected pollutants can be observed together with antimicrobial effect. It has been discovered that the two aforementioned phenomena are difficult to separate. The reactive form of oxygen degrades the natural environment of the biofilm surrounding the adherent microorganisms, thus impairing the conditions required for the life cycle of the microorganisms under consideration. In addition, the natural antimicrobial effect related to a direct effect of singlet oxygen on selected microorganisms can be observed.

With respect to all the aforementioned activities, it can be understood, based on a detailed analysis, that the photoactive process depends on a plurality of other effects; the microorganisms are sensitive to the action of singlet oxygen to a different extent and the cause of such differences is unknown. If it is caused by the degradation of their natural environment due to the organic pollutant deactivation, then more viable microorganisms survive and so do the microorganisms with a more complex cell wall, such as Gram-negative bacteria, that are more resistant. The disadvantage is that because of the physical character of the polymer film, direct interaction of light, pollutants, or microorganisms, natural air humidity and the photo-active agent able to generate singlet oxygen at a given wavelength can be limited, thus resulting in the effect about an order of magnitude lower with inefficient decontamination of the surface concerned.

The purpose of the invention is to prepare water-borne hybrid varnish showing sufficient efficacy against both yeasts and Gram-positive bacteria, and Gram-negative bacteria and functioning under various light conditions (daylight, artificial light, dark), regardless of the fact that the concentration of the standard biocidal preparation is approaching the allowed concentration limit imposed by the applicable legislation. Furthermore, the varnish must create a thin film with good film-forming capacity, gas permeability, and porosity.

### SUMMARY OF THE INVENTION

The set goal has been solved by the water-borne hybrid varnish based on the silicone-acrylate-urethane thermosetting polymer according to the present invention. The essence of the invention consists in the fact that the water-borne varnish comprises an additive in the form of standard biocidal preparation intended for the protection of films and coatings against microbial degradation or algae growth or for the preservation of fibrous or polymer materials, such as leather, rubber or paper, or textile products against microbial degradation, at the same time comprising a photo-active component based on a phthalocyanine derivative with the central atom of aluminium or zinc. The phthalocyanine derivative is present in the varnish in the form of either dispersion with a size of particles ranging from 100 to 200 nm, where the size of particles is chosen with respect to the photo-active efficacy of the nanoparticles and their availability, or is bound in the varnish via a reactive bond in the polymer matrix at a concentration ranging from 0.05 to 1.0% by weight where the phthalocyanine derivative is bound via a covalent bond. Such a composition of the polymer antimicrobial layer provides an increased total protective action, in particular in the case of the air, light, pollutant, and photo-active component interaction. The protective action is based on the synergistic effects of the combination of a biocidal preparation in the minimal concentration and a photo-active organic derivative capable of a singlet oxygen generation when irradiated by light with a wavelength ranging from 500 to 700 nm.

For the purposes of the present disclosure, the term “standard biocidal preparation” refers to any biocidal preparation present in the water-borne hybrid varnish in a quantity not exceeding the limits imposed by the applicable legislation due to its toxicity and harmful effects on human health. Such a standard biocidal product is selected from a group of the seventh and ninth group of biocidal preparations (PT7 and PT9), characterized by Regulation (EU) No 528/2012 of the European Parliament and of the Council.

For the purposes of the present disclosure, the term “water-borne hybrid varnish” refers to a water-borne inorganic-organic polymer system.

The present invention deals with the creation of water-borne hybrid varnish providing permanent protection of exposed surfaces that are in regular contact with a number of persons, in particular in public areas, such as banks, public administration premises, schools, or shops against microbial contamination. Such protection is permanent and independent of exposure to light and with no harmful effect on human health. This condition is partially resolved by the addition of biocidal preparations designed to protect films and coatings or to preserve fibrous or polymer materials provided that they are dosed in concentrations still ensuring biostatic effect, meaning reducing the number of microorganisms by up to 90%. Biocidal preparations in such doses prevent further growth and proliferation of the adherent microorganisms. In addition, the concentration of the biocidal preparations is low enough to eliminate any possible negative side effects on the health of users of the surfaces treated in this manner, in particular from a dermatological point of view. Functioning of such protection is independent of the treated surface illumination. Efficient protection against the transfer of microorganisms adherent on the surface specified above is then provided by the photo-active component that is activated by light present in all the aforementioned areas. The combination of the biocidal and photo-active components of the coating systems designed to protect exposed surfaces thus provides biocidal protection during the standard use if exposed to daylight as well as artificial light and biostatic protection during dark periods.

In a preferred embodiment, the silicone-acrylate-urethane thermosetting polymer matrix comprises a reactive group to bind the phthalocyanine derivative selected from the following group: alcohol, diol, polyol, alcohol amine, amino alcohol, primary amine, secondary amine, amides or carboxylic acid, and/or a combination thereof.

In another preferred embodiment, the standard biocidal preparation comprises a biocidal agent selected from the following group: 1-[[2-(2,4-dichlorophenyl)-4-propyl-1,3-dioxolan-2-yl]methyl]-1H-1,2,4-triazole, azoxystrobin, 1,2-benzisothiazole-3(2H)-on, (benzothiazole-2-ylthio)methyl thiocyanate, bronopol, 2-butyl-benzo[d]isothiazol-3-on, carbendazim; p-chloro-m-cresol, 4,5-dichloro-2-octylisothiazole-3(2H)-on, 4,5-dichloro-2-octyl-2H-isothiazole-3-on, dimethyloctadecyl[3-(trimethoxysilyl)propyl]amonnium chloride, dimethyltetradecyl[3-(trimethoxysilyl)propyl]amonnium chloride, fludioxonil; 3-iodo-2-propynylbutylcarbamate, N-(trichloromethylthio)phthalimide, 2-octyl-2H-isothiazol-3-on, pyridine-2-thiol 1-oxide, zinc pyrithione, sodium pyrithione, silver nanoparticles, mixture of silver chloride and titanium dioxide, silver adsorbed on silicon dioxide, silver zinc zeolite, sodium dimethyldithiocarbamate, 2-thiazol-4-yl-1H-benzoimidazole, lactic acid, sodium acetate, sodium benzoate, (+)-tartaric acid, acetic acid, propionic acid, ascorbic acid, oct-1-en-3-ol, (Z,E)-tetradec-9,12-dienyl acetate, iron citronellal or sulphate.

The essence of the invention also consists in the specific method of preparation of the water-borne hybrid varnish in two variants. In the first variant, the hybrid silicone-acrylate-urethane thermosetting polymer is prepared by chemical synthesis of the primary diisocyanate skeleton with a multi-purpose hydroxyl-type of methacrylate monomer and polydimethylsiloxane diol. Furthermore, the synthesis is terminated by either hydroxyl- or amine-type of methacrylate monomer that is added, upon the synthesis termination, phthalocyanine derivatives in the form of a water dispersion of an unsubstituted pigment with particles of a size ranging from 100 to 200 nm, and subsequently a biocidal preparation is mixed into the hybrid polymer system.

In the second variant, the method of preparation of the water-borne hybrid varnish is such that the hybrid silicone-acrylate-urethane thermosetting polymer is prepared by chemical synthesis of the primary diisocyanate skeleton with a multi-purpose hydroxylic type of methacrylate monomer and polydimethylsiloxane diol. During the synthesis, phthalocyanine derivatives are added to the silicone-acrylate-urethane thermosetting polymer at a concentration ranging from 0.05 to 1.0% by weight and are fixed by a reactive bond; the synthesis is subsequently terminated by either hydroxyl- or amine-type of methacrylate monomer. A biocidal preparation is then mixed into the hybrid polymer system. Such a method of synthesis of the antimicrobial polymer film is optimal for attaining stable fixation of the photo-active system in the silicone-acrylate-urethane polymer via a covalent bond between the photo-active agent and the silicone-acrylate-urethane polymer.

In a preferred embodiment, polymerization is terminated by a monomer selected from the following group: N-hydroxyethylacrylamide, 2-hydroxypropylacrylate, 4-hydroxybutylacrylate, hydroxypropylmethacrylate, 2-hydroxyethylmethacrylate, 3-phenoxy-2-hydroxypropylmethacrylate, glycerolmonomethacrylate, N-(2-hydroxypropyl)methacrylamide, hydroxypolyethoxy allyl ether; 1,4-butandioldiacrylate, 1,6-hexanedioldiacrylate, N-vinylacetamide, acrylamide N-iso-propylacrylamide, N-dodecylacrylamide, N-(3-aminopropyl)methacrylamide, N-(3-BOC-aminopropyl)methacrylamide, 2-aminoethylmethacrylate, methacryloyl-L-lysine, N-[3-(N,N-dimethylamino)propyl]methacrylamide, N-(2-aminoethyl)methacrylamide, N-benzylmethacrylamide, N-[2-(N,N-dimethylamino)ethyl]methacrylamide, (N,N-dimethylamino)ethylmethacrylate, 2-(tert-butylamino)ethylmethacrylate, 2,2-bis[4-(2-hydroxy-3-methacryloxypropoxy)phenyl]propane, diurethandimethacrylate, 4-methacryloxy-2-hydroxybenzophenon, pentaerythritoldiacrylate, pentaerythritoltriacrylate, dipentaerythritolpentaacrylate, or their methacrylate analogues.

The essence of the invention further consists in the fact that it also comprises a product with applied water-borne hybrid varnish according to the present invention comprising polyethylene terephthalate-based or polyethylene-based touch film, the surface of which is treated with the water-borne hybrid varnish according to the present invention prepared based on the method according to the present invention.

In a preferred embodiment, such touch film is transparent. The transparent film is preferred thanks to its application onto touch displays, in particular of payment terminals, thus preventing such surfaces from undesirable communication of bacteria and viruses between individual users.

The advantages of the water-borne hybrid varnish, according to the present invention, consist in particular in the fact that the water-borne hybrid varnish comprises a photo-active agent active in the visible portion of the spectrum with efficacy in particular against yeasts and Gram-positive bacteria, in synergistic combination with a biocidal preparation comprising a biocidal agent active in particular against Gram-negative bacteria. The advantages of the water-borne hybrid varnish according to the present invention further consist in the fact that the photo-active and biocidal agents are incorporated in the carrier polymer system that is designed to create a thin film with good film-forming capacity, gas permeability, and porosity, and due to the interaction of air, light, pollutants, and photo-active agent the total protective action is synergistically increased, regardless of the fact that the concentration of the standard biocidal preparation is approaching the concentration limit imposed by the applicable legislation and the manufacturer.

### EXAMPLES OF THE INVENTION EMBODIMENTS

### Example 1: Testing of the Prepared Surface Photo-Activity

### The DPIBF in Hex Method

The employed method is based on the decomposition of indicator, 1,3-diphenylisobenzofurane or DPIBF generated by singlet oxygen in a solvent environment that is hexane in this case. A sample of dimensions of 0.7×0.7 cm prepared according to Examples 1 through 13 was put into a cuvette; then 3.5 ml of hexane solution was added together with the solution of DPIBF in hexane to attain the value of absorbance A_{412nm˜}0.9 at the absorption maximum of the indicator. The used laser source of radiation emitted radiation at a wavelength of 661 nm. The samples were measured at regular intervals using UV/VIS spectrometry (Shimadzu), and the value of the sample photo-activity was recorded as the half-life T_{1/2} of the DPIBF decomposition according to the following formula:

$${τ}_{1 / 2} = ( ln ( 2 ) / k ) * 25$$

Where:
k is the slope of the time dependence of DPIBF indicator absorbance decrease (ln(A)).

### The DPP Method

The employed method is based on a decrease of the model derivative agent, diketopyrrolopyrrole so-called DPP, that was applied onto the tested surfaces in the form of a thin film. Onto the samples having a size of 3×4 cm, 250 μl of the DPP derivative in hexane (0.4 mg/ml) was applied to form a thin layer. The samples prepared in this manner were dried in a drying chamber (Memmert) at a temperature of 50° C. and then placed under the Narva Red source of radiation. The samples were measured at regular intervals using the fluorescent spectrometer (Scinco) at the DPP fluorescence emission maximum, at a wavelength of 524 nm. The photo-activity of the samples was then expressed as a half-life of decomposition T_{1/2}, which is determined based on the decrease of the DPP derivative in time.

### Example 2: Testing of Antimicrobial Properties

For the purposes of Example 2, the ISO 22196:2011 standard was employed with modification concerning the sample incubation under artificial daylight. Surface samples of the films surface-treated by varnish comprising an active phthalocyanine derivative and/or other biocidal preparations were cut into pieces with dimensions 25×25 mm, and covering polypropylene film was cut into pieces with dimensions 20×20 mm. Both the samples and the covering film were disinfected before testing by submerging them in 70% ethanol. Bacterial suspensions comprising a number of the order of 10⁵ CFU/ml of the tested strain were prepared. A total of 100 μl of bacterial suspension was applied onto the samples, which were then covered by the polypropylene film. One half of the samples were incubated at a temperature of 35° C. and 95% RH for 18 hours at a distance of 30 cm from the source of artificial daylight (Narva LT, D65), and the other half of the samples were incubated in the dark under the same conditions as specified in the standard mentioned above. Then the applied quantity of the bacterial suspension was washed away by rinsing medium, and the number of viable bacteria expressed as CFU/ml was ascertained by cultivation at a temperature of 35° C. for 48 hours. The testing was carried out with three parallel samples. The value of microbial activity R was calculated according to the following formula:

$$R = ( {U}_{t} - {U}_{0} ) - ( A t - {U}_{0} )$$

Where:
R refers to antibacterial activity,
Uₜ refers to the average of the decadic logarithms of the numbers of bacteria (colony forming units, CFU) ascertained in the tested control samples after 18 hours of incubation,
U₀ refers to the average of the decadic logarithms of the numbers of bacteria (CFU) ascertained in the three tested samples immediately after inoculation,
Aₜ refers to the average of the decadic logarithms of the numbers of bacteria (CFU) ascertained in the tested samples with antibacterial treatment after 18 hours of incubation.

For verbal interpretation of results, the ČSN EN ISO 20743:2014 standard was followed.

### Example 3: Preparation of the Silicone-Acrylate-Urethane Thermosetting Polymer

The following ingredients were added into a sulfonation flask with four necks: 10.15 g of polydimethylsiloxandiol, 65 g of polyesterdiol based on 1,6-hexandiol and adipic acid, 13 g of triethylamine, and 0.25 g of 2,6-di-tert-butyl-4-methylphenol. Then stirring of the reaction mixture was activated, the reactor was filled with argon, and while stirred at a speed of 200 to 250 rpm, the content of the flask was heated up to a temperature of 60° C. Subsequently, 195 g of dicyclohexylmethane diisocyanate [31.95% by weight NCO; Mw 263], 60 g of 2-ethylhexylacrylate, 15 g of 2-hydroxyethylacrylate, and 5.5 g of pentaerythritoltriacrylate was added. Upon completion of dosing, the reaction mixture was gradually heated, in the course of 45 minutes, up to a temperature of 90° C. and then stirred constantly for a period of 2 hours. Then additional ingredients of the mixture were prepared, specifically: 61 g of dimethylolpropionic acid, 20 g of butylmethacrylate, 10 g of hydroxyethylmethacrylate, and 3.3 g of 3-acryloyloxy-2-hydroxypropylmethacrylate. This reaction mixture was further maintained at a temperature of 90° C. for 2 more hours. Then the content of the flask was cooled down to 80° C., and the following ingredients were dosed into the reactor: 0.95 g of ethylenediamine, 15 g of N,N-dimethylaminoethanol, and 50 g of distilled water. After allowing the reaction to proceed for 5 minutes, dispersing of the polymer system by gradual adding of 525 g of distilled water followed. Then the content of the flask was cooled down to 40° C., and the following ingredients were dosed: 19 g of butoxymethylacrylamide, 5 g of methylmethacrylate, 7 g of butylacrylate, and 100 g of distilled water. The reaction mixture was stirred for 30 more minutes followed by cross-linking of the latex acrylic component. Under intense cooling, the following ingredients were added to 1,000 g of the dispersion: 1 g of tert-butyl hydroperoxide (70% by weight, aqueous solution) in 10 g of distilled water followed by 0.17 g of ammonium ferrous sulphate and 1 g of sodium bisulphite in 43 g of water. The final product was allowed to react for 30 more minutes in the reactor, and then it was filtered into a storage bottle.

### Example 4: Preparation of the Silicone-Acrylate-Urethane Thermosetting Polymer with Fixed Phthalocyanine so-Called “FTC” Comprising a Methacrylate Functional Group so-Called “HEMA” in its Molecule and with a Concentration of 1% by Weight of the Photo-Active Additive

The following ingredients were added into a sulfonation flask with four necks: 180.15 g of polydimethylsiloxandiol, 183 g polyesterpolyol on the basis of 1,6-hexandiol, 13 g of triethylamine, 40 g of dimethylolpropionic acid, 14.5 g of ZnFTC-HEMA so-called phthalocyanine comprising the methacrylate functional group, and 2.5 g of 2,6-di-tert-butyl-4-methylphenol. Then stirring of the reaction mixture was activated, the reactor was filled with argon, and while stirred at a speed ranging from 200 to 250 rpm, the content of the flask was heated up to a temperature of 60° C. Subsequently, 468 g of isophorondiisocyanate, 91 g of 2-ethylhexylacrylate, 137 g of isobornylmethacrylate, and 137 g of pentaerythritoltriacrylate was added. Upon completion of dosing, the reaction mixture was gradually heated, in the course of 45 minutes, up to a temperature of 90° C. and them stirred constantly for a period of 2 hours. Then additional ingredients of the mixture were prepared, specifically: 61 g of dimethylolpropionic acid, 55 g of butylmethacrylate, 31 g of hydroxyethylmethacrylate, and 24 g of 3-acryloyloxy-2-hydroxypropylmethacrylate. This reaction mixture was further maintained at a temperature of 90° C. for 2 more hours. Then the content of the flask was cooled down to 80° C., and the following ingredients were dosed into the reactor: 7.3 g of ethylenediamine, 53 g of N,N-dimethylaminoethanol, and 450 g of distilled water. After allowing the reaction to proceed for 75 minutes, dispersing of the polymer system by gradual adding of 2.5 l of distilled water followed. Then the content of the flask was cooled down to 40° C., and the following ingredients were dosed 23 g of butoxymethylacrylamide, 65 g of methylmethacrylate, 72 g of butylacrylate, and 550 g of distilled water. The reaction mixture was stirred for 30 more minutes followed by cross-linking of the acrylic component. Under intense cooling, the following ingredients were added to 1,000 g of the dispersion: 1 g of tert-butyl hydroperoxide (70% by weight, aqueous solution) in 10 g of distilled water followed by 0.17 g of ammonium ferrous sulphate and 1 g of sodium bisulphite in 43 g of water. The final product was allowed to react for 30 more minutes in the reactor, and then it was filtered into a storage bottle.

### Example 5: Preparation of the Silicone-Acrylate-Urethane Thermosetting Polymer with Fixed Phthalocyanine so-Called “FTC” Comprising an Amino Group in its Molecule and with a Concentration of 0.5% by Weight of the Photo-Active Additive

The following ingredients were added into a sulfonation flask with four necks: 62.5 g of polydimethylsiloxandiol and 67.3 g of polydimethylsiloxandiol, 194 g of polyesterpolyol on the basis of 1,4-hexandiol and adipic acid, 7.3 g of triethylamine, 23 g of dimethylolpropionic acid, 20 g of trimethylolpropane, 7.15 g of ZnFTC-amine so-called phthalocyanine comprising the amino functional group, and 2.5 g of 2,6-di-tert-butyl-4-methylphenol. Then stirring of the reaction mixture was activated, the reactor was filled with argon, and while stirred at a speed of 200 to 250 rpm, the content of the reactor was heated up to a temperature of 70° C. Subsequently, 266 g of isophoronediisocyanate and 273 g of methylenebiscyclohexyldiisocyanate, 65 g of 2-ethylhexylacrylate, 70 g of butylacrylate, 106 g of isobornylmethacrylate, and 34 g of pentaerythritoltriacrylate was added. Upon completion of dosing, the reaction mixture was gradually heated, in the course of 45 minutes, up to a temperature of 90° C. and then stirred constantly for a period of 2 hours. Then additional ingredients of the mixture were prepared, specifically: 15 g of styrene, 23 g of dimethylolpropionic acid, 120 g of butylmethacrylate, 12 g of hydroxyethylmethacrylate, and 24 g of 3-acryloyloxy-2-hydroxypropylmethacrylate. This reaction mixture was further maintained at a temperature of 90° C. for 2 more hours. Then the content of the flask was cooled down to 80° C., and the following ingredients were dosed into the reactor: 9 g of ethanolamine, 35 g of N,N-dimethylaminoethanol, and 400 g of distilled water. After allowing the mixture to react for a period of 75 minutes, dispersing of the polymer system followed by gradual addition of distilled water (approximately 3.33 l) to the required concentration of the polymer component 30±0.5% by weight was attained. Then the content of the flask was cooled down to 40° C., and the following ingredients were dosed 23 g of butoxymethylacrylamide, 65 g of methylmethacrylate, 72 g of butylacrylate, and 550 g of distilled water. The reaction mixture was stirred for 30 more minutes followed by cross-linking of the acrylic component. Under intense cooling, the following ingredients were added to 1,000 g of the dispersion: 1 g of tert-butyl hydroperoxide (70% by weight, aqueous solution) in 10 g of distilled water followed by 0.17 g of ammonium ferrous sulphate and 1 g of sodium bisulphite in 43 g of water. The final product was allowed to react for 30 more minutes in the reactor, and then it was filtered into a storage bottle.

### Example 6: Preparation of the Silicone-Acrylate-Urethane Thermosetting Polymer with Fixed Phthalocyanine Comprising Cyclic Secondary Amine and with a Concentration of 0.1% by Weight of the Photoactive Additive

The following ingredients were added into a sulfonation flask with four necks: 62.5 g of polydimethylsiloxandiol and 67.3 g of polydimethylsiloxandiol, 194 g of polyesterpolyol on the basis of 1,4-hexandiol and adipic acid, 7.3 g of triethylamine, 23 g of dimethylolpropionic acid, 20 g of trimethylolpropane, 1.54 g of ZnFTC-pip so-called phthalocyanine comprising cyclic secondary amine, and 2.5 g of 2,6-di-tert-butyl-4-methylphenol. Then stirring of the reaction mixture was activated, the reactor was filled with argon and while stirred at a speed of 200 to 250 rpm, the content of the reactor was heated up to a temperature of 70° C. Subsequently, 234 g of isophoronediisocyanate and 260 g of methylenebiscyclohexyldiisocyanate, 65 g of 2-ethylhexylacrylate, 70 g of butylacrylate, 106 g of isobornylmethacrylate, and 34 g of pentaerythritoltriacrylate was added. Upon completion of dosing, the reaction mixture was gradually heated, in the course of 45 minutes, up to a temperature of 90° C. and then stirred at this temperature for a period of 2 hours. Then additional ingredients of the mixture were prepared, specifically: 15 g of styrene, 23 g of dimethylolpropionic acid, 120 g of butylmethacrylate, 12 g of hydroxyethylmethacrylate, and 24 g of 3-acryloyloxy-2-hydroxypropylmethacrylate. This reaction mixture was further maintained at a temperature of 90° C. for 2 more hours. Then the content of the flask was cooled down to 80° C., and the following ingredients were dosed into the reactor: 9 g of ethanolamine, 35 g of N,N-dimethylaminoethanol, and 400 g of distilled water. After allowing the mixture to react for a period of 5 minutes, dispersing of the polymer system followed by gradual addition of approximately 3.65 l of distilled water to the required concentration of the polymer component 30±0.5% by weight was attained. Then the content of the flask was cooled down to 40° C. and the following ingredients were dosed: 23 g of butoxymethylacrylamide, 65 g of methylmethacrylate, 72 g of butylacrylate, and 550 g of distilled water. The reaction mixture was stirred for 30 more minutes followed by cross-linking of the acrylic component. Under intense cooling, the following ingredients were added to 1,000 g of the dispersion: 1 g of tert-butyl hydroperoxide (70% by weight, aqueous solution) in 10 g of distilled water followed by 0.17 g of ammonium ferrous sulphate and 1 g of sodium bisulphite in 43 g of water. The final product was allowed to react for 30 more minutes in the reactor and then it was filtered into a storage bottle.

### Example 7: Preparation of the Silicone-Acrylate-Urethane Thermosetting Polymer with Fixed Phthalocyanine and with a Concentration of 0.5% by Weight of the Photoactive Additive

The following ingredients were added into a sulfonation flask with four necks: 62.5 g of polydimethylsiloxandiol and 67.3 g of polydimethylsiloxandiol, 194 g of polyesterpolyol on the basis of 1,4-hexandiol and adipic acid, 7.3 g of triethylamine, 23 g of dimethylolpropionic acid, 20 g of trimethylolpropane, 6.91 g of ZnFTC-diol so called phthalocyanine, and 2.5 g of 2,6-di-tert-butyl-4-methylphenol. Then stirring of the reaction mixture was activated, the reactor was filled with argon, and while stirred at a speed of 200 to 250 rpm, the content of the reactor was heated up to a temperature of 70° C. Subsequently, 169 g of isophoronediisocyanate and 165 g of methylenebiscyclohexyldiisocyanate, 65 g of 2-ethylhexylacrylate, 70 g of butylacrylate, 106 g of isobornylmethacrylate, and 34 g of pentaerythritoltriacrylate was added. Upon completion of dosing, the reaction mixture was gradually heated, in the course of 45 minutes, up to a temperature of 90° C. and then stirred constantly for a period of 2 hours. Then additional ingredients of the mixture were prepared, specifically: 15 g of styrene, 23 g of dimethylolpropionic acid, 120 g of butylmethacrylate, 12 g of hydroxyethylmethacrylate, and 24 g of 3-acryloyloxy-2-hydroxypropylmethacrylate. This reaction mixture was further maintained at a temperature of 90° C. for 2 more hours. Then the content of the flask was cooled down to 80° C., and the following ingredients were dosed into the reactor: 9 g of ethanolamine, 35 g of N,N-dimethylaminoethanol, and 400 g of distilled water. After allowing the mixture to react for a period of 5 minutes, dispersing of the polymer system followed by gradual addition of 3.22 l of distilled water to the required concentration of the polymer component 30±0.5% by weight was attained. Then the content of the flask was cooled down to 40° C. and the following ingredients were dosed 23 g of butoxymethylacrylamide, 65 g of methylmethacrylate, 72 g of butylacrylate, and 550 g of distilled water. The reaction mixture was stirred for 30 more minutes followed by cross-linking of the acrylic component. Under intense cooling, the following ingredients were added to 1,000 g of the dispersion: 1 g of tert-butyl hydroperoxide (70% by weight, aqueous solution) in 10 g of distilled water followed by 0.17 g of ammonium ferrous sulphate and 1 g of sodium bisulphite in 43 g of water. The final product was allowed to react for 30 more minutes in the reactor, and then it was filtered into a storage bottle.

### Example 8: Preparation of Varnish Comprising Zinc Phthalocyanine ZnFTC in the Form of Microdispersion

Preparation of the aqueous dispersion of ZnFTC:

300 g of zinc phthalocyanine so-called ZnFTC was gradually mixed into 700 g of a mixture prepared by mixing 496 g of water, 200 g of Disperbyk 190 dispersing agent, and 4 g of BYK 019 anti-foam agent. The mixture was milled in the laboratory Dyno Mill KDL bead mill with the use of glass beads No. 5. In the course of milling, the mixture was diluted by water plus dispersing agent in the ratio of 2:5. The resulting dispersion comprised 9% by weight of ZnFTC in the form of particles the size of which was <300 nm, with the median of the particle size 135 nm (ascertained by the method of dynamic light scattering).

The ZnFTC dispersion was homogeneously introduced into the varnish, the preparation of which is disclosed in Example 3 to attain the resulting concentration of ZnFTC 1% by weight in the varnish dry matter.

### Example 9: Preparation of Varnish Comprising Aluminium Phthalocyanine AIFTC in the Form of Microdispersion

Preparation of the aqueous dispersion of AIFTC:

150 g of aluminium phthalocyanine so-called AIFTC was gradually mixed into 350 g of a mixture prepared by mixing 248 g of water, 100 g of Disperbyk 190 dispersing agent, and 2 g of BYK 019 anti-foam agent. The mixture was milled in the laboratory Dyno Mill KDL bead mill with the use of glass beads No. 5. In the course of milling, the mixture was diluted by water plus dispersing agent in the ratio of 2:5. The resulting dispersion comprised 23.8% by weight of AIFTC in the form of particles the size of which was <300 nm, with the median of the particle size 170 nm, which was ascertained by the method of dynamic light scattering.

The AIFTC dispersion was homogeneously introduced into the varnish, the preparation of which is disclosed in Example 3 to attain the resulting concentration of AIFTC 1% by weight in the varnish dry matter.

### Example 10: Varnish for the Preparation of the Film with Improved Antimicrobial Protection Comprising Zinc Phthalocyanine in the Form of Microdispersion and Preventol CMKNa

For the purposes of Example 10, a standard biocidal preparation was employed, specifically biocidal preparation Preventol CMKNa (Lanxess)—PT 9; being 100% sodium p-chloro-m-cresolate, and the efficient dosing of Preventol CMKNa is within the range from 0.08 to 0.64% by weight. With dosing lower than 0.1607% by weight, the final product does not need to be marked, not even by phrase EUH 208, due to its low risk for human health. Preventol CMKNa was dissolved in water to form 25% by weight solution and dosed into the varnish prepared according to Example 8, so that the concentration of the active substance sodium p-chloro-m-cresolate in the varnish dry matter was under the lower limit for the active substance. The concentration of sodium p-chloro-m-cresolate in the varnish was 0.020 and 0.028% by weight per dry matter of the formulation. At the same time, varnish comprising only the dispersion system used for the preparation of the zinc phthalocyanine dispersion and with no content of biocidal preparation was prepared. The varnishes were applied onto transparent polypropylene film using a box ruler with a slot size of 35 μm. Drying was allowed under laboratory conditions. The resulting layers were tested in terms of photo-activity and antibacterial properties. The results of the tests are provided in Table 1.

TABLE 1
The results of the tests of photoactivity and antibacterial
properties of the film comprising zinc phthalocyanine in the
form of microdispersion together with Preventol CMKNa.

| | Content of | | | | |
|---|---|---|---|---|---|
| Content of | CMKNa [% | | | S. aureus | |
| ZnFTC [% by | by weight] | T_{1/2} | T_{1/2} | CCM 4516 | |
| weight] in varnish | in varnish | (s) | (h) | Inhibition [%] | |
| dry matter | dry matter | DPIBF | DPP | Light | Dark |
| 1 | 0.020 | 854 | 56 | 63 | 0 |
| 1 | 0.028 | 889 | 66 | 93 | 85 |
| 0 (reference sample) | 0 | 3,151 | >168 | — | — |

The values of half-lives T₁12 for both tested indicators confirm the production of singlet oxygen by present ZnFTC in the form of submicron dispersion in both varnishes comprising 1% by weight of ZnFTC and 0.020% by weight or 0.028% by weight of Preventol CMKNa. The reference sample showed a high value of half-life and no production of singlet oxygen. Considering the absence of biocidal preparation in the reference sample, no inhibition action on the tested bacterial strain was observed. The sample comprising 1% by weight of ZnFTC and 0.020% by weight of Preventol CMKNa shows a weak inhibition action when illuminated, meaning that the concentration of 0.020% by weight of Preventol CMKNa is not sufficient for the inhibition of the bacterial strain concerned. The concentration of Preventol CMKNa 0.028% in the varnish in combination with 1% by weight of ZnFTC showed efficient inhibition of the tested bacterial strain in the dark, and at the same time, the value of inhibition increased due to the co-action of ZnFTC when exposed to light. As it follows from Table 1, due to the synergistic action of the agents attained by an increase in the Preventol CMKNa agent concentration by 40%, inhibition of S. aureus CCM 4516 increased by 85% in the dark and by 30% when exposed to light.

### Example 11: Varnish for the Preparation of the Film with Improved Antimicrobial Protection Comprising Phthalocyanine Fixed in a Polymer Matrix and a Biocidal Preparation on the Basis of Silver Chloride and Titanium Dioxide

For the purposes of Example 11, a standard biocidal preparation was employed, specifically commercially available biocidal preparation JMAC™ LP 10 (Clariant)—PT 7, 9; and 16% by weight of a dispersion of silver chloride and titanium dioxide with a concentration of silver chloride of 2% by weight. The recommended dose levels in liquid aqueous formulations fall within the range from 0.25 to 1.0% by weight of JMAC™ LP 10. The varnish, the preparation of which is disclosed in Example 4, was mixed with biocidal preparation JMAC™ LP 10 to obtain the concentration at the upper dose level, meaning 1.0% by weight in the varnish dry matter. The formulation prepared in Example 4 was used as a reference sample. The varnishes were applied onto a transparent polypropylene film using a box ruler with a slot size 35 μm and allowed to dry. The resulting layers were tested in terms of photo-activity and antibacterial properties, and the results of the tests are provided in Table 2.

TABLE 2
The results of the tests of photoactivity and antibacterial
properties of varnishes comprising JMAC ™ LP 10
(Clariant)-PT 7, 9, silver chloride, and titanium dioxide.

| Content of | JMAC | | | | |
|---|---|---|---|---|---|
| ZnFTC-HEMA | LP 10 [% by | | | | |
| [% by weight] | weight] in | T_{1/2} | T_{1/2} | E. coli CCM | |
| in varnish | varnish dry | (s) | (h) | 4517 R | |
| dry matter | matter | DPIBF | DPP | Light | Dark |
| 1 | — | 470 | 3.3 | 5.8 | 0 |
| 1 | 1 | 628 | 5.2 | ≥5.8 | 5.1 |

The values of half-lives T_{1/2} for both tested indicators confirm the production of singlet oxygen by the present ZnFTC fixed in the polymer matrix, thus proving the excellent self-cleaning properties comparable in both samples. The value of antibacterial activity R expressing the logarithmic decrease in the number of microorganisms compared to a control sample has proven the excellent biocidal properties of this commercially available biocidal preparation in the dark. Nevertheless, the complete reduction of the tested bacterial strain was only possible when exposed to light with the co-action of JMAC™ LP 10 and ZnFTC.

### Example 12: Varnish for the Preparation of the Film with Improved Antimicrobial Protection Comprising Phthalocyanine Fixed in a Polymer Matrix and Zinc Pyrithione or PyrZn

For the purposes of Example 12, a standard biocidal preparation was employed, specifically commercial biocidal preparation UltraFresh KW48 (Nearchimica SpA)—PT 7, 9. This agent refers to the dispersion of zinc pyrithione PyrZn in water comprising 48% by weight of PyrZn, and the recommended dosing ranges from 200 to 300 mg of Zn per kg of dry matter. The varnish, the preparation of which is disclosed in Example 4, was doped by mixing with UltraFresh KW48 supplied as aqueous dispersion comprising 48% by weight of PyrZn. The PyrZn preparation was added into the varnish at a concentration far below the lower limit of the recommended dose, specifically 0.0052% by weight of Zn in the varnish dry matter, and at the lower limit of the recommended dose, meaning 0.0200% by weight of Zn in the varnish dry matter; the results of the tests are provided in Table 3.

TABLE 3
The results of the tests of photoactivity and antibacterial properties of the varnish comprising
UltraFresh KW 48 (Nearchimica SpA)—PT 7, 9 together with zinc pyrithione.

| Content of | | | | | | | |
|---|---|---|---|---|---|---|---|
| ZnFTC-HEMA | Content of Zn | | | | | E. coli | |
| [% by weight] | [% by weight] | | | S. aureus | | CCM 4617 | |
| in varnish | in varnish dry | T_{1/2} (S) | T_{1/2} (h) | R | | R | |
| dry matter | matter | DPIBF | DPP | Light | Dark | Light | Dark |
| 1 | — | 470 | 3.3 | ≥ 3.3 | 1.1 | 5.8 | 0 |
| 1 | 0.0052 | 501 | 4.7 | ≥ 3.3 | 1.8 | 5.8 | 0.7 |
| 1 | 0.0200 | 370 | 6.1 | ≥ 4.6 | 4.5 | 3.7 | 3.8 |

As it follows from the example of embodiment, even with a very low concentration of the standard biocidal preparation on the basis of PyrZn in combination with an organic photoactive agent, it is possible to attain a very efficient inhibition of the tested bacterial strain. The combination of a photoactive agent, specifically a phthalocyanine derivative at a concentration of 1% by weight, with a standard biocidal preparation, specifically PyrZn at a concentration far below the lower limit of the recommended dose (0.0052% by weight) had a synergistic effect on the increase of antibacterial activity R of the prepared varnish. As it follows from Table 3, even the limiting quantity of the standard biocidal preparation shows antibacterial activity in the dark, and when exposed to light, the value of the antibacterial activity is comparable to the lower recommended limiting dose for the standard biocidal preparation PyrZn (0.0200% by weight) if 1% by weight of the photoactive preparation, specifically a phthalocyanine derivative, is added.

### Example 13: Varnish for the Preparation of the Film with Improved Antimicrobial Protection Comprising Phthalocyanine Fixed in a Polymer Matrix and Iron Sulphate

The varnish, the preparation of which is disclosed in Examples 4 through 7, is doped by iron sulphate in the form of an aqueous solution so that the resulting concentration of iron is 1% by weight of the varnish dry matter.

### Example 14: Testing of Antimicrobial Activity

The tested samples:
1. PET films used as a reference so-called control sample,
2. PET films, the surface of which is treated by varnish comprising 1% by weight of ZnFTC-HEMA fixed in a polymer matrix, and 0.020% by weight of Zn in the dry matter of the varnish, the preparation of which is disclosed in Example 12,
3. PET films, the surface of which is treated by varnish comprising 1% by weight of ZnFTC-HEMA fixed in the polymer matrix, the preparation of which is disclosed in Example 4.

In principle, the determination of antimicrobial activity was carried out as per the ISO 22196:2011 standard with modification of sample incubation under a light source and with the use of bacteriophages. Two types of bacteriophages were employed for testing. One of them was [symbol] X174, non-encapsulated, single-stranded DNA virus of the E. coli bacterial strain. The properties of this resistant bacteriophage correspond to those of viruses causing intestinal flu, poliomyelitis, and noroviruses. In addition, encapsulated bacteriophage [symbol] 6, which is used as an alternative to viruses such as those that cause Covid-19, influenza, HIV, and ebola, was employed for testing.

The samples of 2.5×7.5 cm were glued onto an object glass. The tested samples and the covering film were disinfected before testing using 70% ethanol. The phage lysate for the testing of antimicrobial activity was diluted by bacteriophage buffer to attain a concentration of 9.5×10⁵ PFU/ml for [symbol] X174 and 4.3×10⁵ PFU/ml for [symbol] 6. The samples were placed on sterile Petri dishes; the phage lysate of a volume of 0.1 ml was applied onto each sample three times one next to another, then each sample was covered by sterile inert covering PP film with dimensions 2.0×2.0 cm. With the control sample, the lysate was immediately washed away, meaning at time zero, to control the correct implementation of the test. The other samples, both control and subjected to antimicrobial treatment, were divided into two groups. The first group was incubated at a temperature of 35° C. for [symbol] X174 or at 25° C. for [symbol] 6 and 95% RH for 24 hours when the samples were also exposed to light from a distance of 30 cm by a source of artificial daylight, specifically two tubes NARVA LT, 36 W/D65, artificial daylight. The other group of samples was incubated under the same conditions in the dark in accordance with conditions imposed by the ISO 22196:2011 standard. Then the applied amount of lysate was washed away from the samples, and the titre of the bacteriophage (PFU/ml) was determined by cultivation using the method of gradual dilution and pouring into agar at a temperature of 35° C. for [symbol] X174 or at 25° C. for [symbol] 6 for a period of 24 hours.

The value of antibacterial activity R was calculated according to the ISO 22196:2011 standard using the formula disclosed above.

Table 4 provides the results of plaque concentration acquired from one cm² of the tested sample as the average value of the three parallel samples, their logarithm, and antibacterial activity R, meaning the difference of the logarithms of plaque concentration of the untreated sample incubated in the dark, i.e., the reference sample, and the sample subjected to antibacterial treatment. The efficacy of the antimicrobial properties is provided in Table 5 according to the ČSN EN ISO 20743: 2014 standard. The bacteriophage [symbol] X174 manifested slightly increased degradation when exposed to light; therefore, the resulting value of efficacy of the samples was reduced by the value R of the reference sample when exposed to light.

TABLE 4
The result of plaque concentration acquired from one cm² of
the tested sample as the average value based on three parallel
samples, where the bacteriophage [symbol] X174 manifested slightly
increased degradation when exposed to light; therefore,
the resulting value of efficacy of the samples was reduced
by the value R of the reference sample when exposed to light.

| | | [symbol] X174 | | Φ 6 | |
|---|---|---|---|---|---|
| Sample | | log N | R | log N | R |
| 1 | Immediately | 5.0 | — | 4.4 | — |
| (reference | washed away | | | | |
| sample) | Exposure to | 4.1 | 0.9 | 4.4 | 0.1 |
| | light | | | | |
| | Dark | Ut = 5.0 | — | Ut = 4.5 | — |
| 2 | Exposure to | 2.6 | 1.5 | <1 | 4.5 |
| | light | | | | |
| | Dark | 4.9 | 0.1 | <1 | 4.5 |
| 3 | Exposure to | 2.0 | 2.1 | <1 | 4.5 |
| | light | | | | |
| | Dark | 4.9 | 0.1 | 2.0 | 2.5 |

TABLE 5
The description of efficacies of antimicrobial properties,
taken over* from the C̆SN EN ISO 20743: 2014 standard.

| Efficacy of | Value of |
|---|---|
| antimicrobial properties | antimicrobial action R |
| Weak | 1 < R < 2 |
| Significant* | 2 ≤ R < 3 |
| Strong* | R ≥ 3 |

As it follows from the results provided in Table 4, the PET sample with the varnish comprising 1% by weight of ZnFTC-HEMA and 0.020% by weight of PyrZn manifested weak antimicrobial efficacy against non-encapsulated bacteriophage [symbol] X174 when exposed to light and strong antimicrobial efficacy against encapsulated bacteriophage [symbol] 6 when exposed to light as well as when incubated in the dark.

The PET sample with the varnish comprising 1% by weight of ZnFTC-HEMA manifested significant antimicrobial efficacy against the non-encapsulated bacteriophage [symbol] X174 when exposed to light; against the encapsulated bacteriophage [symbol] 6, the efficacy is strong when exposed to light and significant in the case of incubation in the dark.

PyrZn comprised in the varnish according to these results has no inhibiting effect on the bacteriophage [symbol] X174, but when phthalocyanine is added, the biocidal action of the varnish increases and weak to significant action of the varnish is observed. In the case of bacteriophage [symbol] 6, the combination of PyrZn and ZnFTC-HEMA ensured strong efficacy underexposure as well as non-exposure to light.

### Example 15: Test of the Varnishes in a Real Environment

The varnish, the preparation of which is disclosed in Example 12, comprising 1% by weight of ZnFTC-HEMA and 0.02% by weight of PyrZN was applied by the slot die printing technology using the SmartCoater machine set to the rotary mode onto a self-adhesive PET film with a width of 28 cm and dried at a temperature of 140° C. at a speed of application 0.5 m/min. In another, not mentioned example of embodiment, it is possible to apply the film using any printing or application technology according to the state of the art.

With the consent of two operators of chain stores, the films were placed onto touch displays of their either attended or self-service check-out counters. No other illumination was implemented in the area of the said check-out counters; the areas of the said check-out counters were illuminated only by standard interior light fixtures. Always a film with no varnish used as a reference sample was applied to one of the said check-out counters, while two other check-out counters were fitted with the films with the doped varnish. The same arrangement was employed in both chain stores. The said check-out counters with the reference film were subjected to standard maintenance, meaning wiping by towels soaked in disinfecting agent twice a day. The said check-out counters fitted with the film comprising the doped varnish remained with no maintenance by disinfection or any wiping at all and possible replacement of the film. At weekly intervals, samples of the surface contamination were taken by the smear method using a metal fixture made of stainless steel with dimensions 10×10 cm and a sterile cotton swab. The procedure followed the ČSN 56 0100 standard. The samples were taken at the same time. The numbers of ascertained microorganisms such as bacteria, yeasts, and fungi are provided in terms of the number of colony-forming units on the tested area of 100 cm². The values of inhibition are expressed as a percentage and relate to the value ascertained for the reference sample, being the said check-out counter with a clean film on the day when the samples were taken.

TABLE 6
The results of the tests of the varnishes prepared according
to the present invention based on Example 15.

| | Chain store 1 | | | | | Chain store 2 | | | | |
|---|---|---|---|---|---|---|---|---|---|---|
| | Ref. | I | | II | | Ref. | III | | IV | |
| Interval | sample | | Inhibition | | Inhibition | sample | | Inhibition | | Inhibition |
| (weeks) | CFU | CFU | [%] | CFU | [%] | CFU | CFU | [%] | CFU | [%] |
| 1 | 2,070 | 20 | 99 | <1 | 100 | 1,420 | 55 | 96 | 5 | >99 |
| 2 | 660 | 325 | 51 | 140 | 79 | 780 | 155 | 80 | 140 | 80 |
| 3 | 3,210 | 855 | 73 | 210 | 94 | 6,550 | 550 | 92 | 3,105 | 52 |
| 4 | 6,795 | 945 | 86 | 1,325 | 81 | 4,850 | 2,125 | 56 | 1,175 | 76 |

Based on the results acquired by testing under real conditions, the long-lasting antimicrobial effect of the doped varnish can be declared. Regardless of the two-phase daily maintenance of the reference sample surfaces, the contamination of the films with the varnish comprising ZnFTC-HEMA and PyrZn was significantly lower: the minimum ascertained value of inhibition was 51/%; however, in a majority of cases, values exceeding 70% were ascertained.

### INDUSTRIAL APPLICABILITY

The water-borne hybrid varnish according to the present invention can be utilized as surface treatment for long-lasting broad-spectrum protection against adherence of bacteria, viruses, and/or yeasts, specifically for frequently touched places, such as handles or rails in public premises, and/or touch screens of displays in banks, state administration offices, schools, or shops.

1. The water-borne hybrid varnish on the basis of silicone-acrylate-urethane thermosetting polymer, characterized in that it comprises an added biocidal preparation designed to protect films and coatings against microbial degradation or algae growth or to preserve fibrous or polymer materials, such as leather, rubber or paper, or textile products against microbial degradation, and that at the same time comprises a photoactive component based on a phthalocyanine derivative with the central atom of aluminium or zinc being in the form of aqueous dispersion with the size of particles ranging from 100 to 200 nm, or being bound in the varnish via a reactive bond in the polymer matrix at a concentration ranging from 0.05 to 1.0% by weight.

2. The water-borne hybrid varnish according to claim 1, characterized in that the silicone-acrylate-urethane thermosetting polymer matrix comprises a reactive group to bind the phthalocyanine derivative selected from the following group: alcohol, diol, polyol, alcohol amine, amino alcohol, primary amine, secondary amine, amides or carboxylic acid, and/or a combination thereof.

3. The water-borne hybrid varnish according to claim 1, characterized in that the standard biocidal preparation comprises a biocidal agent selected from the following group: 1-[[2-(2,4-dichlorophenyl)-4-propyl-1,3-dioxolan-2-yl]methyl]-1H-1,2,4-triazole, azoxystrobin, 1,2-benzisothiazole-3(2H)-on, (benzothiazole-2-ylthio)methyl thiocyanate, bronopol, 2-butyl-benzo[d]isothiazol-3-on, carbendazim; p-chloro-m-cresol, 4,5-dichloro-2-octylisothiazole-3(2H)-on, 4,5-dichloro-2-octyl-2H-isothiazole-3-on, dimethyloctadecyl[3-(trimethoxysilyl)propyl]ammonium chloride, dimethyltetradecyl[3-(trimethoxysilyl)propyl]ammonium chloride, fludioxonil; 3-iodo-2-propynylbutylcarbamate, N-(trichloromethylthio)phthalimide, 2-octyl-2H-isothiazol-3-on, pyridine-2-thiol 1-oxide, zinc pyrithione, sodium pyrithione, silver nanoparticles, mixture of silver chloride and titanium dioxide, silver adsorbed on silicon dioxide, silver zinc zeolite, sodium dimethyldithiocarbamate, 2-thiazol-4-yl-1H-benzoimidazole, lactic acid, sodium acetate, sodium benzoate, (+)-tartaric acid, acetic acid, propionic acid, ascorbic acid, oct-1-en-3-ol, (Z,E)-tetradec-9,12-dienyl acetate, iron citronellal or sulphate.

4. The method of preparation of the water-borne hybrid varnish according to claim 1, characterized in that the hybrid silicone-acrylate-urethane thermosetting polymer is prepared by chemical synthesis of the primary diisocyanate skeleton with a hydroxylic type of methacrylate monomer and polydimethylsiloxane diol. The synthesis is further terminated by either hydroxyl- or amine-type of methacrylate monomer that is added. Upon the synthesis termination, phthalocyanine derivatives in the form of water dispersion of an unsubstituted pigment with particles of a size ranging from 100 to 200 nm are added, and subsequently a biocidal preparation is mixed into the hybrid polymer system.

5. The method of preparation of the water-borne hybrid varnish according to claim 1, characterized in that the hybrid silicone-acrylate-urethane thermosetting polymer is prepared by chemical synthesis of the primary diisocyanate skeleton with a multi-purpose hydroxylic type of methacrylate monomer and polydimethylsiloxane diol, and during the synthesis, phthalocyanine derivatives at a concentration ranging from 0.05 to 1.0% by weight are added to the silicone-acrylate-urethane thermosetting polymer and fixed in the silicone-acrylate-urethane thermosetting polymer by a reactive bond. The synthesis is subsequently terminated by either hydroxyl- or amine-type of methacrylate monomer, and subsequently a biocidal preparation is mixed into the hybrid polymer system.

6. The method of preparation according to claim 4, characterized in that the polymerization is terminated by a monomer selected from the following group: N-hydroxyethylacrylamide, 2-hydroxypropylacrylate, 4-hydroxybutylacrylate, hydroxypropylmethacrylate, 2-hydroxyethylmethacrylate, 3-phenoxy-2-hydroxypropylmethacrylate, glycerolmonomethacrylate, N-(2-hydroxypropyl)methacrylamide, hydroxypolyethoxy allyl ether; 1,4-butandioldiacrylate, 1,6-hexanedioldiacrylate, N-vinylacetamide, acrylamide N-iso-propylacrylamide, N-dodecylacrylamide, N-(3-aminopropyl)methacrylamide, N-(3-BOC-aminopropyl)methacrylamide, 2-aminoethylmethacrylate, methacryloyl-L-lysine, N-[3-(N,N-dimethylamino)propyl]methacrylamide, N-(2-aminoethyl)methacrylamide, N-benzylmethacrylamide, N-[2-(N,N-dimethylamino)ethyl]methacrylamide, (N,N-dimethylamino)ethylmethacrylate, 2-(tert-butylamino)ethylmethacrylate, 2,2-bis[4-(2-hydroxy-3-methacryloxypropoxy)phenyl]propane, diurethandimethacrylate, 4-methacryloxy-2-hydroxybenzophenon, pentaerythritoldiacrylate, pentaerythritoltriacrylate, dipentaerythritolpentaacrylate, or their methacrylate analogues.

7. The touch film on the basis of polyethylene terephthalate, or polypropylene, or polyethylene, characterized in that its surface is fitted with the water-borne hybrid varnish according to claim 1.

8. The touch film according to claim 7, characterized in that its surface is fitted with the water-borne hybrid varnish prepared using the method according to claim 4.

9. The touch film according to claim 8, characterized in that it is transparent.

10. The method of preparation according to claim 5, characterized in that the polymerization is terminated by a monomer selected from the following group: N-hydroxyethylacrylamide, 2-hydroxypropylacrylate, 4-hydroxybutylacrylate, hydroxypropylmethacrylate, 2-hydroxyethylmethacrylate, 3-phenoxy-2-hydroxypropylmethacrylate, glycerolmonomethacrylate, N-(2-hydroxypropyl)methacrylamide, hydroxypolyethoxy allyl ether; 1,4-butandioldiacrylate, 1,6-hexanedioldiacrylate, N-vinylacetamide, acrylamide N-iso-propylacrylamide, N-dodecylacrylamide, N-(3-aminopropyl)methacrylamide, N-(3-BOC-aminopropyl)methacrylamide, 2-aminoethylmethacrylate, methacryloyl-L-lysine, N-[3-(N,N-dimethylamino)propyl]methacrylamide, N-(2-aminoethyl)methacrylamide, N-benzylmethacrylamide, N-[2-(N,N-dimethylamino)ethyl]methacrylamide, (N,N-dimethylamino)ethylmethacrylate, 2-(tert-butylamino)ethylmethacrylate, 2,2-bis[4-(2-hydroxy-3-methacryloxypropoxy)phenyl]propane, diurethandimethacrylate, 4-methacryloxy-2-hydroxybenzophenon, pentaerythritoldiacrylate, pentaerythritoltriacrylate, dipentaerythritolpentaacrylate, or their methacrylate analogues.
